(19) United States
(12) Patent Application Publication
(10) Pub. No.: US 2009/0020029 A1
(43) Pub. Date: Jan. 22, 2009

(54) Method and apparatus for automatically regulating the registers between imprints in a multi color rotary printing press

(76) Inventor: Klaus Reckefuss, Leopoldshohe (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/218,307

(22) Filed: Jul. 14, 2008

(30) Foreign Application Priority Data
Jul. 13, 2007 (EP) 07013836.7

(51) Int. Cl. B41F 13/24

(52) U.S. Cl. 101/248

(57) ABSTRACT

An apparatus for automatically regulating the register between two imprints being applied individually and successively onto a material web by at least two printing units arranged successively in the direction of travel of the web in a rotary printing press is provided, wherein the printing units being passed successively by the web for this purpose, and wherein a control unit is assigned to each printing unit and is connected to impression rollers assigned to the respective printing units for positioning and print adjustment and is controllable by an automatic control unit being connected to a processing control.

### CROSS-REFERENCE TO RELATED APPLICATIONS

Priority is hereby claimed to European Patent Application No. 07013836.7, filed on Jul. 13, 2007, the entire contents of which are incorporated herein by reference.

### BACKGROUND

The invention relates to a method and an apparatus for automatically regulating the register between imprints (printed images) in a multi color rotary printing press.

In rotary printing presses, the colors in the respective printing units have to be printed in line with a register, superimposedly with respect to each other. If this is not possible, a dowdy and therewith nonmarketable print is generated (i.e., a loss of material is generated). In a continuous printing operation, the register deviation may, for example, be measured by means of a register adjuster and automatically adjusted to the predetermined target position. For this purpose, at least one mark is additionally printed by each printing unit, the respective position of which is measured with respect to a mark printed by another printing unit. Based on a deviation of a target position, a correcting signal is generated, which is then executed by suited means (e.g., register rollers). A register adjuster generally operates such that the marks for measuring the register positions are printed in a relatively small detection window in a circumferential direction. Therefore, the printed images of the printing units to be measured have to be pre-positioned exactly up to a few millimetres during the setting of a print job, such that the marks being printed onto a web are positioned adjacently or successively within the detection window. In order to achieve this, a web length (web path) between the printing units must be set to a specific amount, for example an integer multiple of the printing format (periphery of cylinder). This may be obtained by adjusting the web length between two printing units by means of rollers in the web path, or by adjusting the relative angular positions of the cylinders carrying the printing plate. The resulting roller positions or angular positions in turn depend on the course of the web, the printing format and the extension of the fabric to be printed.

In general, when working without additional assistance, the procedure is such that, for new orders, the complete printing machine is aligned into the register by manually inputting control commands for the rollers in the web path or the positioning means of the form cylinder. The result thereof is monitored by means of a web monitoring system. For an automatic control, the obtained actual positions are then resumed as target positions and stored, and are subsequently maintained constant in an adjusting process. This procedure is very lengthy and depends on the skill of the operator, which, however, inevitably results in a high consumption of material being printed. An absolutely feasible solution includes that a pre-adjustment of the cylinder or web path rollers by means of register spindles (later also referred to as spindle positions) is performed based on positions for each printing format (periphery of cylinder) being measured once. The determination of the target positions includes great effort when implementing the apparatus. Changes of the configuration of the printing unit, the course of the web or the properties of the material (extension) after the pre-positioning still result in considerable register deviations which may even result in the register marks still being located outside the measuring window, such that the desired object fails to appear nearly completely.

Mostly, the parameters required for a preceding arithmetical determination of the amount are not known in advance with a sufficient accuracy, such that it is, in practice, always necessary to perform such a pre-positioning by means of a locating method while the material is moving. In doing so, a considerable amount of material is in any case required, which generates non-marketable products and waste and therefore results in a considerable economical loss.

Therefore, there still exists the need to find a method which reduces material expenses to a minimum and therewith saves material as well as unused machine time.

EP 0 070 565 describes a method in which, in each printing unit, the mark printed by the printing unit is stepwise respectively passed below the sensor directly following the printing unit. Tests performed in the course of the invention showed that this method is very time-consuming and, despite certain enhancements, still uses a considerable amount of material and is not very precise due to mechanic engaging. In addition, it depends, to a large extent, on the skill of the printer to position the marks of the individual printing units in a suitable manner.

EP 1 132 203 B1 offers a considerable enhancement with the idea to automatically perform such a pre-positioning. The basic idea is to perform an automatic determination of any actual positions of marks and a correction thereof by suitably starting and stopping the printing in an iterative process. Hence, at first, printing is started in the last unit and the position of the mark printed therein is detected by the sensor behind this printing unit, and the position signal of a fixed speed sensor, at which the mark was detected, is recorded for this position, and finally, a measuring window is generated around this position. This operation is performed in the apparatus, starting at first from the rear end toward the front end up to the second printing unit, such that a measuring window is formed unambiguously for each printing unit about the mark printed by the respectively preceding printing unit. Subsequently, the same process is performed in the opposite direction, such that printing only occurs in the first printing unit and the mark is set in the center of the measuring window of the sensor behind the second printing unit by adjusting the path of the incoming web. After that, the subsequent printing unit is started and adjusted in the same manner, and so on.

A disadvantage of this method is that a double passage with respectively one press proof in each printing unit is required.

Further, the described method may only be used if respectively only one register mark per printing unit is located in the scanning path of the web scanner. In case other objects or marks are also printed within the scanning path (which often occurs), one code mark per printing unit must be additionally printed with a known distance relative to the marking for recognition. This is disadvantageous since the ID mark requires additional space which enlarges the measuring window and therewith makes the usable space for the motif smaller.

In addition, with respect to gravure printing, changing of existing shapes requires a high financial effort, as required for the supplementary insertion of the code marks.

It is, therefore, an object underlying the present invention to provide a method and an apparatus which overcome the drawbacks of the state of the art and which enable a further saving of material without requiring complex changes of the apparatus.

### SUMMARY

In one embodiment, an apparatus for automatically regulating the register between two imprints being applied individually and successively onto a material web by at least two printing units arranged successively in the direction of travel of the web in a rotary printing press is provided, the printing units being passed successively by the web for this purpose, wherein a control unit is assigned to each printing unit and is connected to impression rollers assigned to the respective printing units for positioning and print adjustment, and are controllable by an automatic control unit being connected to a processing control.

In another embodiment, a method for automatically regulating the registers between imprints being applied individually and successively onto a web by at least two printing units arranged successively in the direction of travel of the web in a rotary printing press is provided, the printing units being passed successively by the web for this purpose, wherein the method comprises: setting the contact pressure in the printing unit being the last in the direction of travel of the web; detecting and storing a speed sensor position detected by a speed sensor, in which position a register mark being printed together with the imprint is detected by a scanning unit arranged behind the printing unit put into operation last in direction of travel of the web; setting the contact pressure of the printing unit arranged in front of the printing unit being put into operation last in the direction of travel of the web; detecting the register mark applied by the printing unit by a scanning unit behind the printing unit following the printing unit in the direction of travel of the web and storing the associated speed sensor position in which the register mark was detected; calculating a correction value for the position of the imprints by comparing the two speed sensor positions such that the correction amount is effective in that, after performing the correction, the two register marks will be located in a finite, predetermined closely adjacent distance; stopping the contact pressure of the printing unit put into operation last and performing the calculated correction by a control unit and again setting the contact pressure of the printing unit; activating an automatic register regulation of the printing unit following the printing unit respectively put into operation last in the direction of travel of the web; and successively repeating the previous method steps for all other printing units upstream in the direction of travel of the web.

Other aspects of the invention will become apparent by consideration of the detailed description and accompanying drawings.

### BRIEF DESCRIPTION OF THE DRAWINGS

FIG. 1 shows a schematically simplified illustration of an inventive rotary printing press or an adjusting device including a cylinder adjustment.

FIG. 2 shows a second embodiment of the inventive rotary printing press or an adjusting device including a register spindle.

### DETAILED DESCRIPTION

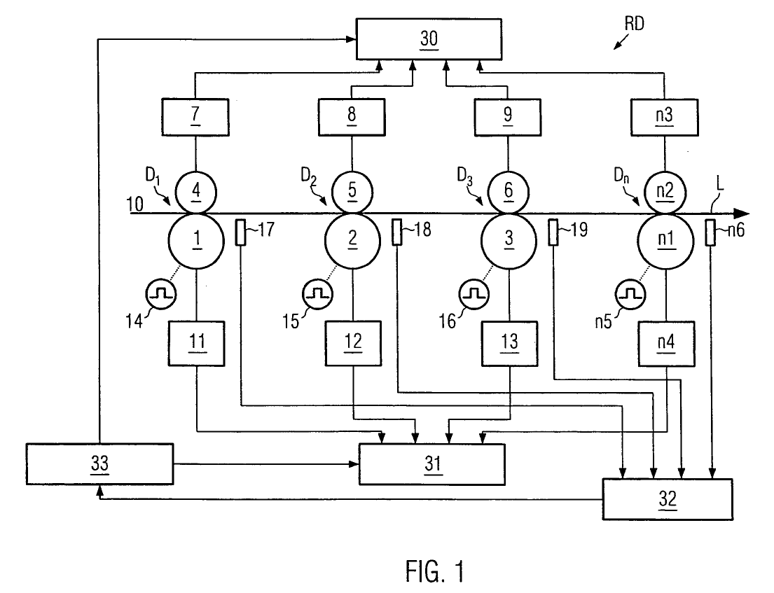

FIG. 1 shows a rotary printing press RD comprising printing units D1, D2, D3 and D_{N} arranged successively in the direction of travel L of a web 10. This means that, dependent on the number of colors to be printed, a corresponding number of printing units is provided, wherein the printing unit D_{N} defines the respectively last printing unit in the direction of travel L. Each of the printing units comprises an associated impression cylinder 1, 2, 3, N1 and an associated impression roller (pressure) 4, 5, 6, N2.

One control unit 7, 8, 9, N3 per printing unit D1 to D_{N} is provided for the position of the impression rollers and the press proof.

Further, a drive control 11, 12, 13, N4 for the impression cylinders 1, 2, 3, N1 is associated to each printing unit D1 to D_{N}.

A speed sensor 14, 15, 16, N5 for detecting the angular position of the respective impression roller 1, 2, 3, N1 is associated to each printing unit D1 to D_{N}.

A measuring system or scanner 17, 18, 19, N6 is provided respectively behind the printing units D1, D2, D2, D_{N} in the direction of travel L, the scanner serving to detect the position of one or more register mark(s) which are printed by the printing units D1, D2, D3, D_{N} onto the web 10 together with the imprint or printed image.

Further, a control unit 30 for the impression rollers 4 to N2 is provided, the control unit being signal-connected to the respective control units 7, 8, 9, N3.

The control unit 30 is further coupled to a processing control 33 which is, in turn, signal-connected or coupled to a control unit 31 for positioning the impression cylinders 1, 2, 3, N1 with angular synchronism. The control unit 31 is, in turn, connected to the drive controls 11, 12, 13, N4. As results from FIG. 1, the measuring systems 17 to N6 are further connected to a calculator 32 for calculating the angular position of the impression cylinders 1, 2, 3, N1 with respect to the printed image. As is further detailed in FIG. 1, the calculator 32 is coupled to the processing control 33.

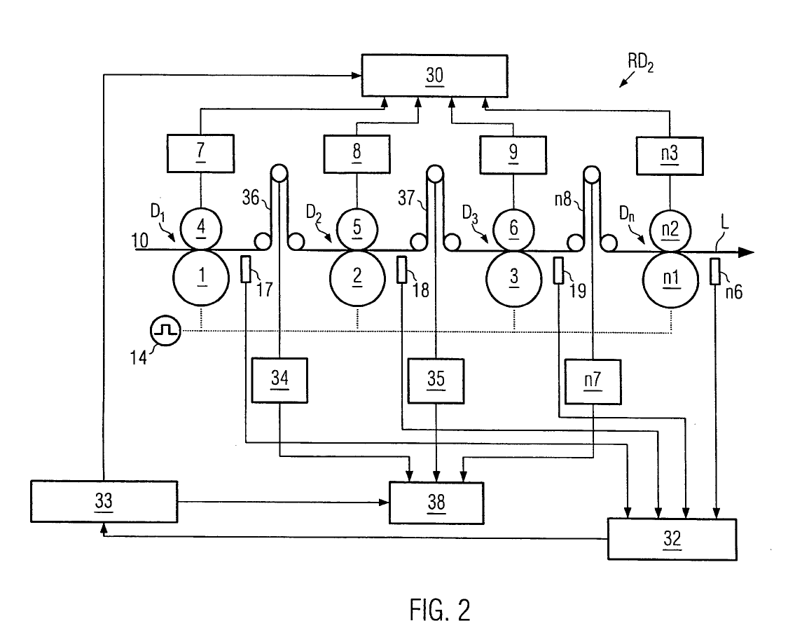

In the embodiment according to FIG. 2, all components corresponding to those of the embodiment of FIG. 1 are designated with the same reference numerals. FIG. 2, however, shows a rotary printing press RD_{R} provided with register spindles 36, 37, N8. Unlike the rotary printing press according to FIG. 1, the register is adjusted in direction of travel L not by the relative angular position of the impression cylinders 1 to N1, but along the web path between the printing units D1 to D_{N} by means of respectively one of the associated register spindles 36, 37, N8, which are respectively arranged behind the printing units D1 to D3 in the direction of travel L.

The embodiment of the invention shown in FIG. 2 further comprises drive units 34, 35 and N7 which serve to position the associated register spindles 36, 37, N8. The drive units 34, and N7 are connected to a control unit 38 for the register spindles, the control unit being coupled to the processing control 33, as results in detail from FIG. 2.

In both embodiments according to FIGS. 1 and 2, the imprints or printed images are printed individually and successively onto the web 10 in the successively arranged printing units D1 to D_{N}, wherein the web 10 passes the printing units D1 to D_{N} in a given order for this purpose. The cylinders 1, 2, 3, N1 carry a printing plate (not shown in detail in FIGS. 1 and 2), and the impression rollers 4, 5, 6, N2 are provided to generate a transfer pressure for generating the imprint onto the web 10, wherein the pressure of the impression rollers (cylinders) 4, 5, 6, N2 may be turned on and off. The calculator 32 and the control unit 33 control the printing units D1 to D_{N} in order to regulate the complete printing process.

In the following, a procedure or a process of pre-positioning according to the invention is described as an example:

a) The impression roller N2 of the last printing unit D_{N} starts to print. A register mark is printed onto the web 10 together with the printed image in the last printing unit D_{N}.

b) In case the scanner head of the web scanner N6 transverse to the direction of travel L is not located in the path of the register mark, the operator positions the scanner head of the web scanner N6 correctly, or the scanner head of the web scanner N6 is automatically pre-positioned by linear adjustment. This linear alignment is an optional step which, of course, need only be performed if the scanner head of the web scanner N6 is actually not correctly adjusted transverse to the direction of travel. According to some embodiments of the invention, it may here be assumed that the deviation of the position of the mark in the lateral direction (if any) is smaller than the width of the mark, which means that the alignment of all scanner heads in accordance with that of the last scanner head of the last web scanner N6 is sufficient.

c) The web scanner N6 arranged behind the impression cylinder N1 searches the position of the register mark in the direction of travel L and inputs the detection of the register mark to the calculator 32.

d) The position of the register mark with respect to the impression cylinder N1 of the last printing unit D_{N} is determined by means of the speed sensor N4 and stored in the calculator 32. Further, a measuring window having a predetermined width is formed around the register mark.

e) The printing unit D3 arranged in front of the printing unit D_{N} in the direction of travel L now starts to print and also prints a printed image and an associated register mark onto the web 10.

f) The web scanner N6 detects the position of the now additionally printed register mark of the printing unit D3 arranged in front of the printing unit D_{N}.

g) The position of the register mark of the impression cylinder 3 of the printing unit D3 with respect to the impression cylinder N1 of the printing unit D_{N} is calculated and stored in the calculator 32.

h) In addition, a difference between the stored register mark positions and the target distance between the marks, which is pre-known by definition, is offset in the calculator 32. The result is transferred to the control unit 33 as a correction value. In doing so, the distance between a virtual zero-point and the register mark printed first is offset with the distance between the zero-point and the register mark printed subsequently. Further, the defined target distance between the register marks is added or subtracted. The control unit 33 now calculates the setting command for the drive control 13 which corrects the angular position of the impression cylinder 3 of the printing D3 accordingly (FIG. 1), or for the drive unit N7 which accordingly adjusts the web path through the register spindle N8 (FIG. 2). In order to obtain a faster adjustment having less effect on the extension in case of larger angular corrections, the impression roller 6 of the printing unit D3 is lifted during the adjustment and lowered thereafter.

j) After the web 10 has passed from the impression cylinder 3 to the web scanner N6, the automatic register regulation for the impression cylinder N1 is activated and the now detected register deviation at the impression cylinder N1 or the register spindle N8 is corrected. This represents an activation of an automatic register regulating unit of the printing unit which is positioned behind the respectively last started printing unit in the direction of travel L, that is in the aforementioned case the printing unit D_{N} which is positioned behind the printing unit D3 in the direction of travel L.

The aforementioned sequence is repeated for the respectively preceding printing unit D2 or D1, until all printing units D1 to D_{N} involved in this print job are adjusted.

After completion of these steps, it is preferred to switch from a sequence control—each printing unit D1 to D_{N} follows its preceding printing unit in the “mark-mark” mode—to a regulation according to a fixed color. However, such an operation is normally not required to obtain register consistency. A regulation according to fixed color refers to a method in which the register errors for each printing unit D1 to D_{N} with respect to a predetermined printing unit, which prints the so-called fixed color, are measured and corrected accordingly. It is advisable that this predetermined printing unit is the first printing unit D1.

With this method, already the machine is regulated without stopping the print job again. When reaching the first printing unit D1 with the aforementioned process, the complete rotary printing press is in a normal and typical state of a register regulation in continuous printing. Therewith, it is possible to further save material during the pre-positioning, since at least one idling cycle is omitted.

In case that other printed elements besides the marks for the register adjuster are located in the path scanned by the measuring head, an unambiguous detection of a mark is also required. By selecting a suitable shape of the mark, this may however be dealt with by usual means. This applies in particular for the commonly used triangular register marks, when the register measuring head is provided with a rectangular mask, wherein the long side of the rectangle is perpendicular to the direction of travel. In this case, it is sufficient to use the typical signal gradient of the flanges and an interjacent expected plateau-shaped gradient of the measuring signal as a criterion to guarantee a sufficient detection in nearly all cases.

Another advantageous embodiment of a sensor is represented by a spectral multi-range scanner (e.g., RGB) which may be used additionally for detecting color. This may be particularly helpful, since one may assume that also spectral identifiers are present when using known colors, which identifiers may then be used in a second level for confirming the detected objects. Such an identifier may also consist of data from a color data bank or of information concerning color parameters transmitted from the pre-press, for example.

The aforementioned encoding and decoding is much simpler if a camera is preferably used as the register measuring head, the camera detecting the shape of the mark in a simple manner according to the usual detection methods of digital image processing. If a color camera is used, the selective color information obtained therewith due to the at least three color channels provided therein may be used in the before-described way additionally or also alone.

With the inventive procedure, the aforementioned drawbacks of the known methods are eliminated or reduced in this way.

Various features and advantages of the invention are set forth in the following claims.

What is claimed is:

1. A method for automatically regulating registers between imprints being applied individually and successively onto a web by at least two printing units arranged successively in a direction of travel of the web in a rotary printing press, the printing units being passed successively by the web for this purpose, the method comprising:
setting a contact pressure in a printing unit being the last in the direction of travel of the web;
detecting and storing a speed sensor position detected by a speed sensor, in which position a register mark being printed together with an imprint is detected by a scanning unit arranged behind the printing unit put into operation last in direction of travel of the web;
setting a contact pressure of a printing unit arranged in front of the printing unit being put into operation last in the direction of travel of the web;
detecting the register mark applied by the printing unit by a scanning unit behind the printing unit following the printing unit in the direction of travel of the web and storing the associated speed sensor position in which the register mark was detected;
calculating a correction value for the position of the imprints by comparing the two speed sensor positions such that the correction amount is effective in that, after performing the correction, the two register marks will be located in a finite, predetermined closely adjacent distance;
stopping the contact pressure of the printing unit put into operation last and performing the calculated correction by a control unit and again setting the contact pressure of the printing unit;
activating an automatic register regulation of the printing unit following the printing unit respectively put into operation last in the direction of travel of the web; and
successively repeating the previous method steps for all other printing units upstream in the direction of travel of the web.

2. The method of claim 1, wherein a lateral positioning of a respective web scanner is performed behind the last printing unit, and all other lateral positioning of web scanners of the upstream printing units are performed automatically.

3. The method of claim 1, wherein a lateral positioning of the web scanners is calculated and performed based on data pre-known from a pre-press.

4. The method of claim 1, wherein executions of the corrections are performed by a drive control or by changing a position of a web guiding roller being inserted into the web path between the printing units such that the web guiding roller is capable of changing the web length between two printing units.

5. The method of claim 1, wherein executions of the calculated corrections are performed by a relative correction of the angular position of the printing unit passed earlier by the material web.

6. The method of claim 1, wherein the method steps are performed simultaneously.

7. The method of claim 1, in which a plurality of register marks per printing unit is imprinted and in which the register mark to be scanned is provided with a code information.

8. The method of claim 7, wherein the register mark comprises at least one edge arranged perpendicular to the direction of travel of the web, wherein at least one further edge is arranged in a predetermined angle and distance to the direction of travel of the web, and wherein these characteristics are used for differentiation with respect to other marks for identification in that the slopes of the flanges of the edges are formed when passing below a scanning head being provided with a slot-shaped mask having a longitudinal extension perpendicular to the direction of travel of the web for this purpose.

9. The method of claim 7, in which all marks printed by respectively one printing unit are provided with different colors, wherein a scanning in at least two spectral ranges is performed in the scanning heads and the fractions of each range detected therewith are used as a code for differentiating between a printed register mark and the respectively other printed colors, wherein the spectral fractions of each of the printed register marks are pre-known such that a superimposed printing of marks is recognized in that an expected combination of fractions is not sufficiently existent.

10. An apparatus for automatically regulating a register between two imprints being applied individually and successively onto a material web by at least two printing units arranged successively in the direction of travel of the web in a rotary printing press, the printing units being passed successively by the web for this purpose, comprising: a control unit assigned to each printing unit and connected to impression rollers assigned to respective printing units for positioning and print adjustment and being controllable by an automatic control unit connected to a processing control.

11. The apparatus of claim 10, wherein all printing units are connected to a common speed sensor.

12. The apparatus of claim 10, characterized in that each printing unit is connected to its own speed sensor.
